(19) United States
(12) Patent Application Publication
(10) Pub. No.: US 2012/0028051 A1
(43) Pub. Date: Feb. 2, 2012

(54) IMPROVED STAIN RESISTANCE

(75) Inventors: Keith William Critchley, Merseyside (GB); Paul Arthur Holmes, Cheshire (GB)

(73) Assignee: Pilkington Group Limited, St. Helens (GB)

(21) Appl. No.: 12/998,857

(22) PCT Filed: Dec. 11, 2009
(86) PCT No.: PCT/GB2009/051688

§ 371 Date: Aug. 16, 2011

(30) Foreign Application Priority Data
Dec. 12, 2008 (GB) 0822696.1

(51) Int. Cl. B32B 17/06; C03B 35/00; B05D 3/02

(52) U.S. Cl. 428/426; 427/372.2; 65/181

(57) ABSTRACT

A method of improving the stain resistance of a surface of a glass article such as a float glass ribbon or float glass sheet is disclosed. The method comprises the steps of (i) applying a solution comprising a stain inhibitor to an absorbent strip; (ii) transferring solution from the wet strip to the surface of the glass article; and (iii) drying the wet glass surface to leave stain inhibitor on the surface of the glass article. A facility for manufacturing the glass article incorporating an apparatus for applying a solution comprising a stain inhibitor to the surface of the glass article in accordance with the aforementioned method is also disclosed.

The present invention relates to a method of improving the stain resistance of a surface of a glass article and to a facility for producing a glass article comprising an apparatus for applying a stain inhibitor to a surface of the glass article.

It is well known to one skilled in the art that glass can corrode when exposed to water or humid conditions. The problem of glass corrosion is particularly evident when glass sheets are stored in a pack, for example a pack of soda-lime-silica glass sheets produced by a float process.

For a soda-lime-silica glass, it is thought that corrosion of a glass surface in the presence of water involves sodium ions being leached out of the glass surface and into the water. As the level of sodium in the water increases, the pH of the solution in contact with the glass surface increases, accelerating the corrosion process and causing the glass surface to be etched. The resulting alkaline solution can cause the silicate structure of the glass to dissolve, which can then react with calcium oxide in the glass to precipitate insoluble deposits of calcium silicate on the glass surface. The combined effect of the etching process and the accumulation of insoluble deposits on the surface is to create a hazy glass surface. This haziness is usually referred to as “stain”.

For a glass sheet, surface stain can cause a reduction in the optical transmission of the sheet and the hazy appearance is often not acceptable to customers. Surface stain can also prevent the glass sheet from being used in applications where the glass sheet is used as a substrate, for example in the application of metal coatings to the glass surface using a sputtering technique under vacuum.

In order to improve the stain resistance of soda-lime-silica glass such as float glass, the surface of the annealed float glass that has not been in contact with the tin bath is normally covered with a protective layer. The protective layer is designed to prevent alkaline attack that results when sodium is leached from the glass and dissolves in the water in contact with the glass surface. Whilst sheets of paper may be used as the protective layer, usually the protective layer comprises a weak acid, such as adipic acid, to neutralise the alkaline solution that is formed on the glass surface due to sodium leaching. Adipic acid has been used for many years in the glass industry as a stain inhibitor.

In the glass industry, a stain inhibitor adheres to the glass surface to protect the glass but must be able to be washed off with water to expose the glass surface.

One conventional method of applying the protective layer to a sheet of float glass is to mix adipic acid powder with polymethylmethacrylate (PMMA) beads, the mixture being sprayed onto the glass sheet immediately before stacking the sheet in a pack. The PMMA beads act as an interleavant to separate the individual glass sheets in the pack, thereby helping to prevent abrasion from glass surface to surface contact. The application of powders to the surface of a glass sheet is not without problems. Powders can be difficult to apply uniformly and are prone to “caking” in the feed hopper, thereby requiring the feed system to be cleaned before application of the stain inhibitor can be resumed.

It is possible to apply a weak acid stain inhibitor in liquid form, for example an aqueous solution. A typical “stain inhibitor” solution contains less than 5% by weight adipic acid dissolved in deionised water. Often a low level i.e. less than 0.5% by weight, of a suitable surfactant is also present to aid dispersion of the solution on the glass surface. Known methods of applying the solution comprising the weak acid stain inhibitor to the surface of a glass sheet are spraying, dip coating, meniscus coating, flood coating, rollers and brushes.

Each of these conventional methods of applying a stain inhibitor solution has associated problems. Spraying has the problem that spray nozzles may become blocked, thereby disrupting the application of the stain inhibitor. In addition, spraying a float glass ribbon normally requires suitable extraction to reduce potential environmental effects. Dip coating is not suitable for glass sheets produced continuously because of the need to dip the glass sheet into a bath of the solution comprising the stain inhibitor. The bath must be at least as deep at the major dimension of the glass sheet in order to fully coat the glass surface with the solution. Meniscus coating makes it possible to apply the solution to a lower surface of a glass sheet, whereas it may be the opposite upper surface that needs application of the stain inhibitor. Application of the stain inhibitor solution to a float glass ribbon by a roller has the problem that non-uniform pressure exerted by the roller on the glass surface across the ribbon width may result in non-uniform application of the solution (and hence the stain inhibitor). Application by brushes also suffers from the problem that the stain inhibitor solution may be applied non-uniformly.

The present invention addresses the issues associated with these known methods of applying a stain inhibitor in liquid form.

Accordingly the present invention provides from a first aspect a method of improving the stain resistance of a surface of a glass article comprising (i) applying a solution comprising a stain inhibitor to an absorbent strip; (ii) transferring solution from the wet strip to the surface of the glass article; and (iii) drying the wet glass surface to leave stain inhibitor on the surface of the glass article.

Within the context of the present invention, a stain inhibitor improves the stain resistance of a glass surface and can be removed from the glass surface by washing with water. Preferably the stain inhibitor is soluble in water.

It is also to be understood that in the context of the present invention, the surface of the glass article may have a coating thereon, in which case the surface of the glass article may have a different chemical composition to the bulk glass composition. The coating may have been applied by atmospheric pressure chemical vapour deposition, by sputtering under vacuum, by a sol gel process or other such well known coating processes. The stain inhibitor may be applied to the coated glass surface.

In a preferred embodiment a portion of the absorbent strip is covered by an outer layer and the solution is transferred to the surface of the glass article by contacting the outer layer with the glass surface. This has the advantage that the outer layer can protect the absorbent strip from damage.

Preferably the outer layer is separate to the absorbent strip and is attached thereto.

Preferably the outer layer comprises a nylon. Preferably the outer layer is woven from a single monofilament.

The outer layer acts as a protective layer that is harder wearing than the absorbent strip, but still allows the solution to be transferred from the absorbent strip to the glass surface.

Preferably the absorbent strip is held in a fixed position and the glass article is moved relative to the strip so that a film of the solution is applied to the surface of the glass article.

In a most preferred embodiment the absorbent strip comprises a felt.

Methods according to the first aspect of the invention are suitable for applying a stain inhibitor that is soluble in water to the surface of the glass article. Preferably the stain inhibitor is chosen from the group consisting of adipic acid, zinc nitrate and boric acid.

Methods in accordance with the first aspect of the invention are particularly suited for applying a stain inhibitor to a surface of a float glass ribbon. As is well known in the art, a float glass ribbon is a ribbon of glass that has been formed on a molten bath of metal, normally tin. Float glass is usually a soda lime silica composition, but the glass may have a different composition that is compatible with the float process, for example a borosilicate composition. The formed float glass ribbon usually has a substantially constant width. The float glass ribbon has a continuous length and is cut into appropriately sized sheets that are then stacked in packs for shipping to customers.

Preferably the stain inhibitor is applied to the upper surface of the float glass ribbon. By “upper”, it is meant the surface of the float glass ribbon that has not come into contact with the molten metal bath i.e. the means used to form the glass into a flat glass article (the float glass ribbon). The upper surface of the float glass ribbon may have a coating thereon, the coating having been by a sol gel process or a chemical vapour deposition process, usually carried out at atmospheric pressure.

Preferably the absorbent strip is configured to transfer the solution across the width of the float glass ribbon.

In another preferred embodiment, the glass article is a pane of glass. The pane may be a pane that has been cut from a float glass ribbon, that is, the pane may not have yet been stacked in a pack. The pane may be a pane that has been removed from a pack of glass panes. The pane may have been subsequently processed, for example the pane may be curved.

Methods in accordance with the first aspect of the invention preferably apply the solution uniformly to the surface of the glass article. This has the advantage that the stain inhibitor is applied uniformly to the surface of the glass article when the wet glass surface is dried. By being applied uniformly to the surface of the glass article, it is meant that preferably the variation of the weight of stain inhibitor applied to the glass surface in two adjacent areas, each area having the same dimensions, is less than 30%, more preferably less than 20%, even more preferably less than 10%.

Methods in accordance with the first aspect of the present invention may be used to uniformly deposit low amounts of stain inhibitor to the glass surface, such that acceptable stain resistance is provided to the glass surface. However it will readily be appreciated that by altering the rate at which the solution is applied to the absorbent strip, methods in accordance with the first aspect of the present invention may be used to deposit high amounts of stain inhibitor to the glass surface to modify the properties thereof. When the stain inhibitor is adipic acid, a low amount of stain inhibitor applied to the glass surface is in the region of 0.1 g per m², whereas a high amount of stain inhibitor applied to the glass surface is in the region of 1 g per m². Methods in accordance with the present invention may be used to uniformly deposit low and high levels of adipic acid to the upper surface of a float glass ribbon or sheet. Preferably the amount of stain inhibitor, which may be adipic acid, deposited on the glass surface is less than 2 g per m², more preferably in the range 0.1 g per m² and 1 g per m².

In preferred embodiments, the solution is applied to the absorbent strip by at least one dripper such that the solution is dripped onto the absorbent strip. When there is more than one dripper, preferably the flow rate of solution from each of the at least one dripper is substantially the same.

The invention also provides from a second aspect a facility for manufacturing a glass article, particularly a glass sheet, comprising a furnace for producing the molten glass, means for forming the molten glass into the glass article, a heating lehr for cooling the formed glass article, a conveyor mechanism for conveying the cooled formed glass article passed an apparatus arranged to apply a stain inhibitor to a surface of the glass article, the apparatus comprising an applicator being vertically disposed with respect to the conveyor mechanism, the applicator being configured to apply a solution comprising the stain inhibitor to the surface of the glass article and a feed system to supply the solution to the applicator, characterised in that the applicator is a strip of absorbent material. The apparatus may be used to carry out methods in accordance with the first aspect of the present invention.

Preferably the apparatus comprises means for moving the strip of absorbent material between a working configuration wherein the absorbent strip is able to contact the surface of the glass article when supported on the conveyor mechanism and a non-working configuration wherein the absorbent strip is not able to contact the surface of the glass article when supported on the conveyor mechanism.

Preferably the absorbent strip is suspended above the conveyor mechanism.

Preferably the absorbent strip is flexible.

Preferably the absorbent strip is a felt strip.

Preferably the absorbent strip comprises a portion for transferring the solution to the surface of the glass article and a portion for absorbing the solution.

Preferably the absorbent strip comprises an outer layer configured such that the solution is applied to the surface of the glass article via the outer layer.

Suitably the means of supplying the solution to the absorbent strip comprises a dripper that is fed with the solution from a reservoir, the dripper being configured such that solution drips onto the absorbent strip from the dripper. Preferably the reservoir is lower than the conveyor mechanism.

Preferably the absorbent strip is configured such that in use, the absorbent strip is arranged to be substantially channel shaped.

Preferably the facility comprises a drying means configured to dry the solution that has been applied to the surface of the glass article.

Preferably the facility is a float line for producing float glass sheets, the article being a float glass ribbon from which the float glass sheets are cut.

The present invention also provides from a third aspect a glass sheet having a major surface, wherein the major surface is covered by a uniform layer of a stain inhibitor, the stain inhibitor having been applied to the major surface by (i) applying a solution comprising the stain inhibitor to an absorbent strip; (ii) transferring solution from the wet strip to the major surface; and (iii) drying the wet major surface to leave stain inhibitor on the surface thereof. Preferably the glass sheet is a sheet of soda-lime-silica glass, such glass composition having been made using a float process.

Such a glass sheet, which may be flat or curved, has a more uniform resistance to stain than other glass sheets in the prior art. The major surface may have a coating thereon, such that the stain inhibitor covers the coating.

The stain inhibitor may be removed from the major surface by washing with water. Preferably the stain inhibitor is soluble in water. Preferably the uniform layer of the stain inhibitor covers the entire major surface.

Embodiments of the present invention will now be described by way of example only with reference to the accompanying drawings, in which:

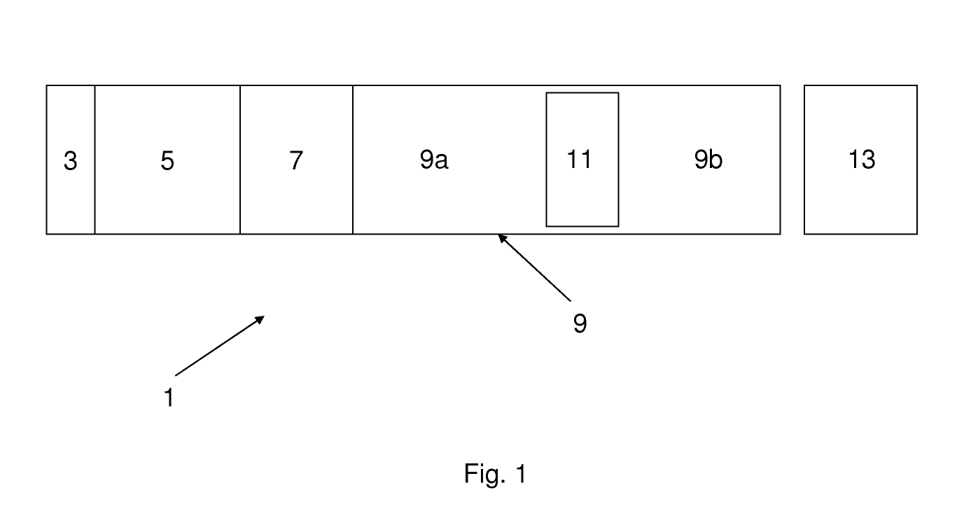

FIG. 1 is a schematic block representation of a facility for manufacturing a glass article in accordance with the second aspect of the invention.

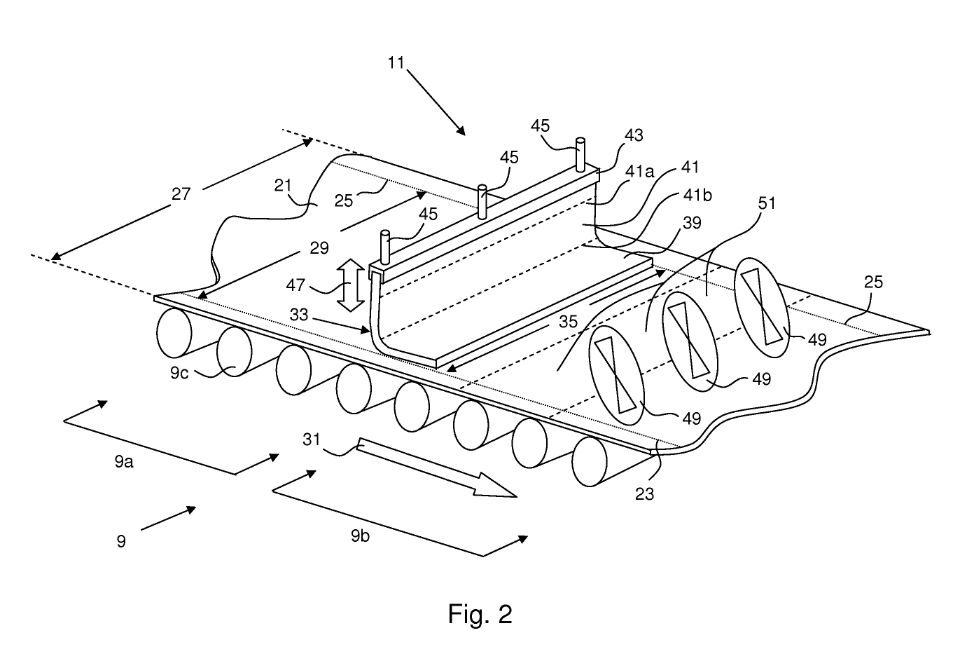

FIG. 2 is a schematic perspective view of part of a facility for manufacturing a glass article in accordance with the second aspect of the invention, showing in more detail part of an apparatus for applying a stain inhibitor to a float glass ribbon, the apparatus being in a working configuration.

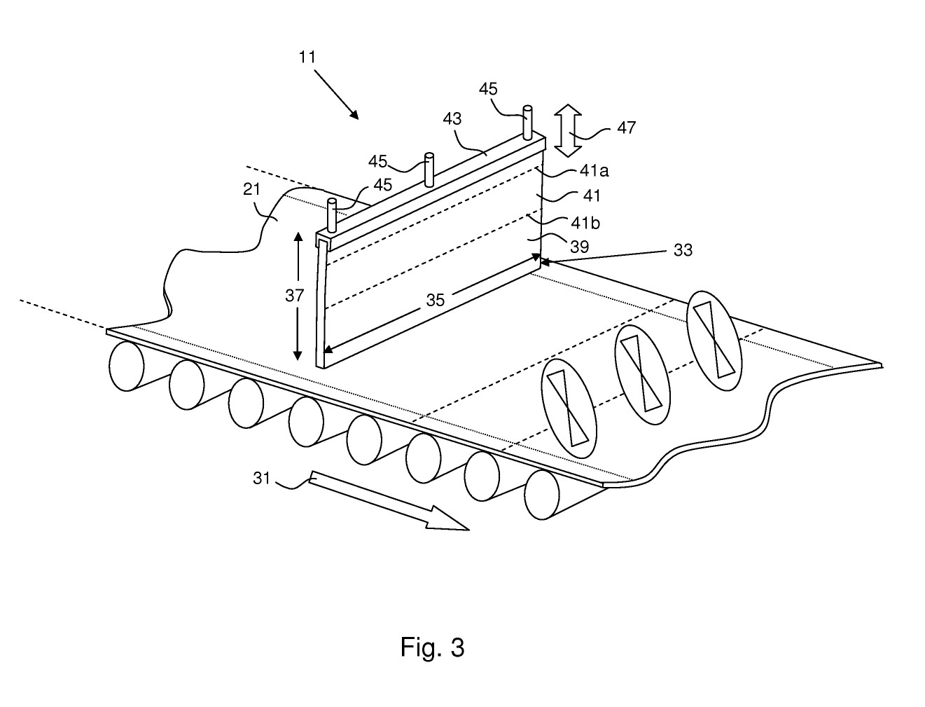

FIG. 3 is a schematic perspective view of part of a facility for manufacturing a glass article in accordance with the second aspect of the invention, showing in more detail part of an apparatus for applying a stain inhibitor to a float glass ribbon, the apparatus being in a non-working configuration.

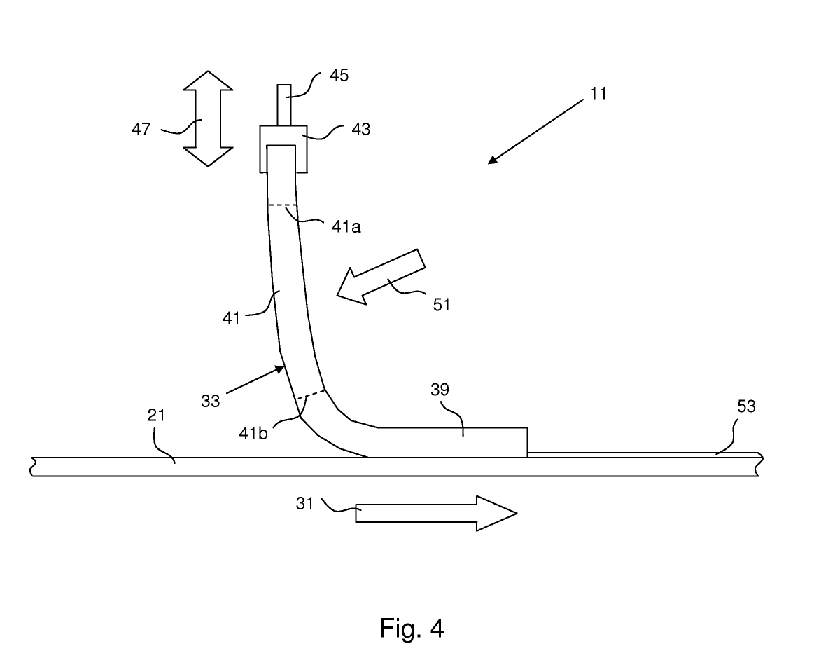

FIG. 4 is a side view of the apparatus shown in FIG. 2.

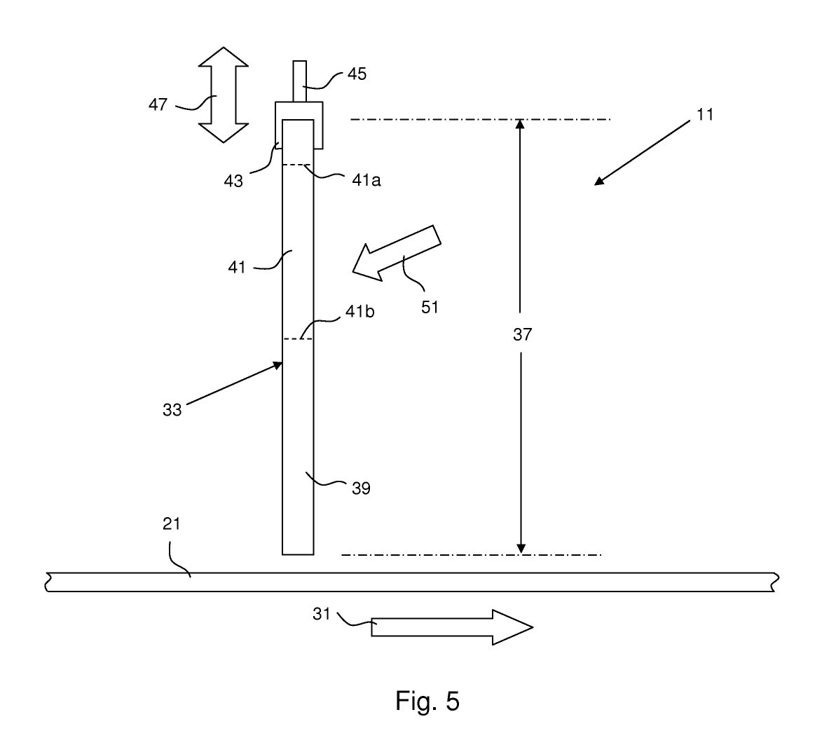

FIG. 5 is a side view of the apparatus shown in FIG. 3.

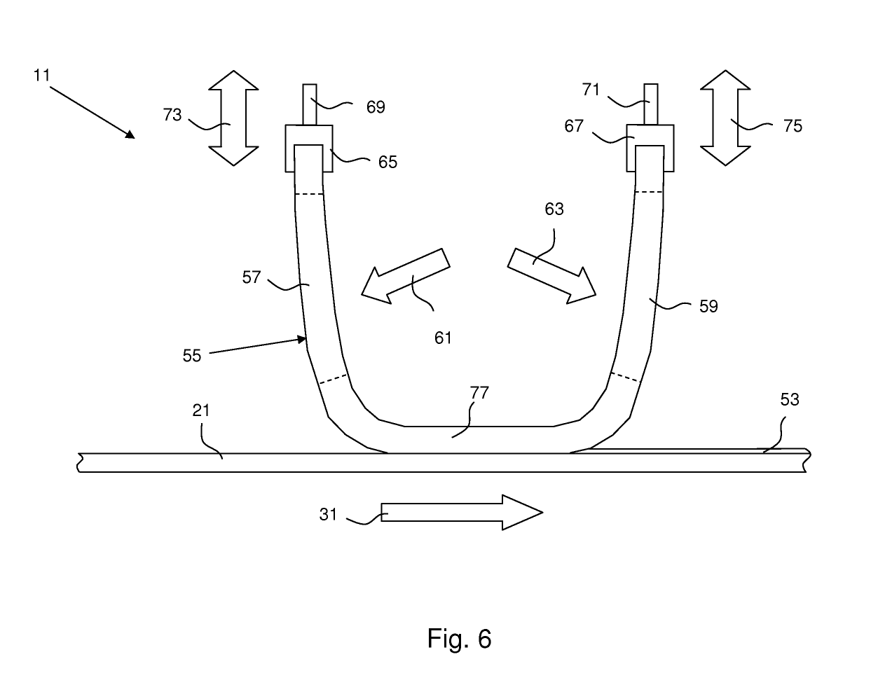

FIG. 6 is a side view of another embodiment in accordance with the second aspect of the present invention, for use in a method in accordance with the first aspect of the present invention.

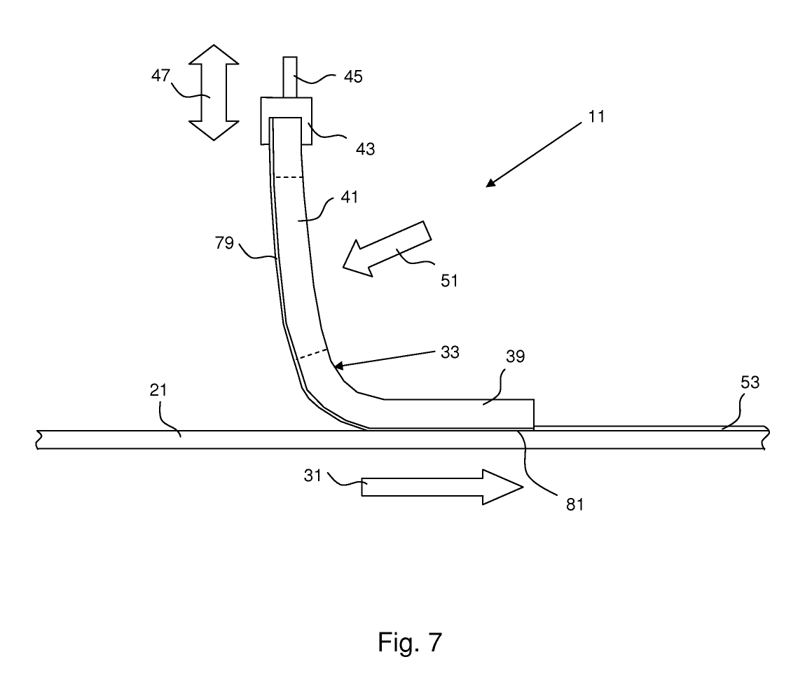

FIG. 7 is a side view of another embodiment in accordance with the second aspect of the present invention, for use in a method in accordance with the first aspect of the present invention.

In FIG. 1 there is shown a block representation of a facility for producing a glass article in accordance with the second aspect of the invention. The facility 1 comprises a raw material feed section 3 for supplying glass making raw materials to a furnace section 5. In furnace section 5, the glass making raw materials are converted to glass by the application of sufficient energy. The glass produced in furnace section 5 is fed to a forming section 7, which may be a float bath, wherein the glass produced in the furnace section 5 is formed into the desired shape necessary to produce the glass article. The formed glass is fed from the forming section 7 onto a conveyor mechanism 9 having a first section 9a which is normally located in a heating lehr (not shown). As the formed glass article is conveyed through the heating lehr, the formed glass article is cooled to relieve stresses i.e. the glass article is annealed. The cooled formed glass article is conveyed passed an apparatus 11 arranged to apply a stain inhibitor to a surface of the glass article. The apparatus 11 comprises an applicator vertically disposed with respect to the conveyor mechanism. The applicator is configured to apply a solution comprising the stain inhibitor to the surface of the glass article. For a flat glass article such as a float glass ribbon or a glass sheet produced by a float process, preferably the applicator applies the stain inhibitor to the upper surface thereof. The apparatus 11 also comprises a feed system to supply the solution to the applicator. In accordance with the second aspect of the invention, the applicator is a strip of absorbent material. The apparatus 11 may be used to carry out a method in accordance with the first aspect of the invention.

The conveyor mechanism 9 also has a second section 9b to convey the glass article towards a stacking section 13. The stacking section 13 arranges the glass article for subsequent storage and shipping to a customer.

When the forming section 7 is a float bath, a float glass ribbon is conveyed on the conveyor section 9a. The float glass ribbon is conveyed passed the apparatus 11. The apparatus 11 is therefore on-line and must be able to be operated continuously over a typical production period. The apparatus must therefore be able to apply the solution (and hence the stain inhibitor) at a rate commensurate with the speed and width of the moving float glass ribbon. Preferably the applicator applies the stain inhibitor to the upper surface of the float glass ribbon. For a float glass ribbon, the section 9b includes a cutting section to cut the glass ribbon into appropriately sized glass panes or sheets. The glass panes are sent to stacking section 13 where they are stacked in packs. The glass sheets or panes may be subsequently processed, for example coated or bent.

In FIG. 2 there is shown part of a facility for manufacturing a glass article. In this particular example, the facility is a float line and the glass article is a float glass ribbon, but may be a glass pane. The float glass ribbon is subsequently cut into other glass articles, namely flat glass sheets or panes.

FIG. 2 shows in more detail an apparatus 11 for applying a stain inhibitor to the upper surface of a float glass ribbon 21. The float glass ribbon 21 has not yet been cut into individual sheets. The glass ribbon 21 has exited a float bath and has been cooled in an annealing lehr (not shown). The glass ribbon still has a line of surface imperfections 23, 25 on the upper surface from rollers in the float bath. These imperfections are cut off the individual sheet before the sheet is stacked and are not present in the sheet that is sold to a customer. The float glass ribbon has a total width indicated by arrow 27. The glass sheets that are subsequently cut will have a width that is less than the separation of the two lines of surface imperfections 23, 25 (this width being indicated by arrow 29).

The apparatus must be able to apply a solution comprising the stain inhibitor to the upper surface of the glass ribbon at a sufficiently high rate compatible with the speed of the moving glass ribbon. As is known in the art, a float glass ribbon moves at high speeds, for example between 100 m/hour and 1200 m/hour and typically the ribbon has a total width of about 3.3 m. The ribbon width may be higher depending upon the particular furnace design. The float glass ribbon has a substantially constant thickness across the entire width and may be in the range 1-25 mm. The upper surface of the float glass ribbon may have a coating thereon, said coating having been deposited by a chemical vapour deposition process, usually carried out at atmospheric pressure. Such coating processes are well known to a person skilled in the art.

The float glass ribbon is supported on a conveyor mechanism 9 that has conveyor sections 9a and 9b. The conveyor mechanism 9 comprises rollers 9c. Rollers 9c may be of different construction in different parts of the conveyor mechanism. The float glass ribbon 21 is conveyed in the direction of arrow 31.

The apparatus 11 comprises a strip of felt 33. In FIG. 2, the strip of felt is shown in the working configuration.

The strip of felt 33 is about 6 mm thick and has two opposed major faces that are substantially rectangular. The strip of felt 33 is flexible and has a strip length 35 that corresponds to the separation 29. Strip length 35 is typically 300 cm. The strip of felt may have a strip length that corresponds to the total ribbon width 27. The strip of felt has a strip width of about 30 cm. The strip of felt is composed of pressed fibres that may be loosely entangled.

The dimensions of the strip of felt 33 are chosen so that when the strip of felt is in the working configuration, a portion 39 of the strip of felt 33 is able to contact the upper surface of the float glass ribbon and a portion 41 of the strip of felt 33 is located above the upper surface of the float glass ribbon. The portion 41 is able to be supplied with the solution that comprises the stain inhibitor. The means of applying the solution to the portion 41 are not shown, but may include a series of spaced drippers extending across the strip length, the drippers being fed from a reservoir that contains the stain inhibitor solution. The drippers are configured to drip the solution comprising the stain inhibitor onto the strip of felt. The drippers may be uniformly spaced. The stain inhibitor solution may be pumped from the reservoir. The reservoir may be lower than the conveyor mechanism 9.

The strip of felt 33 is attached along an upper edge to a metal bar 43 by suitable fixing means. The metal bar 43 is connected via linkage elements 45 to a linear actuator mechanism (not shown) to move the strip of felt vertically with respect to the float glass ribbon (and hence the conveyor mechanism) i.e. in the direction of the arrow 47.

The linear actuator mechanism may be mounted on a bridge such that the conveyor mechanism passes between the legs of the bridge.

In the working configuration shown, the strip of felt 33 is bent so that the cross section thereof is substantially ‘L’ shaped. The lower portion 39 of the felt strip contacts the upper major surface of the float glass ribbon. About 10 cm of the felt strip is in contact with the upper surface of the float glass ribbon.

The upper portion of the felt strip not in contact with the upper major surface is fed with a solution in the region of portion 41. The region of portion 41 extends across the strip length 35 in between dotted lines 41a, 41b. The solution is absorbed by the felt strip and is able to permeate to the lower portion 39 of the felt strip by wicking i.e. by a capillary action. The solution is then transferable from the wet felt strip to the upper major surface of the float glass ribbon. Since the float glass ribbon is moving in the direction of the arrow 31, the solution comprising the stain inhibitor is applied to the upper surface of the float glass ribbon as a film in between the surface imperfections 23, 25.

In an alternative embodiment to that shown, the apparatus 11 applies a stain inhibitor to a glass sheet. In this embodiment, either of the glass sheet or the felt strip applicator may be moved relative to the other to apply the stain inhibitor to the major surface of the glass sheet.

Solution comprising the stain inhibitor is applied to the felt strip at a sufficient rate to wet the strip so that a uniform film may be applied to the glass surface. This ensures that the desired amount of stain inhibitor may be left on the glass surface after the solution has been dried.

In order to provide adequate stain resistance, it is desirable to apply 0.1 g of adipic acid per square metre to the surface of a float glass ribbon or sheet. For a typical stain inhibitor solution comprising 1.4% by weight adipic acid, the volume of liquid to be applied to one square metre of the glass surface is therefore about 7 ml. In order to provide uniform stain resistance over the entire one square metre of the glass surface, this volume of stain inhibitor solution must be uniformly applied to the glass surface. Given that a small drop from a burette is normally taken to be about 0.05 ml, this means that about 140 drops of the stain inhibitor solution must be applied to one square metre of the glass surface. A small drop of water from a burette will only spread to a spot about 5-8 mm in diameter (depending upon the surface tension), so the 140 drops will not cover the one square metre of the glass surface without additional spreading (the area of the 140 drops being about 0.007 m² i.e. only 0.7% of the required area to be covered).

Whilst it is possible to dilute the solution so that even more droplets are applied, this makes drying the solution that is on the glass surface more difficult because more solvent must be evaporated to leave the stain inhibitor on the glass surface. Another alternative is to atomise the solution, but as has been mentioned before, there are problems with using sprays, namely that the spray nozzles may become blocked, and that suitable extraction must be provided in order to reduce potential environmental effects.

The present invention solves this problem by providing a method and apparatus that is capable of spreading the solution uniformly over the glass surface so that the appropriate level of stain inhibitor may be applied thereon.

To improve the uniformity of the applied solution, preferably the solution is applied uniformly across the length 35 of the felt strip applicator. The stain inhibitor solution may be applied at regularly spaced intervals across the width of the felt strip applicator by a series of regularly spaced drippers configured to drip solution at the appropriate rate onto the felt strip applicator. For felt strip applicator that has a length 35 of 3 m, preferably the drippers are spaced between 50 mm and 100 mm apart. Preferably there are forty drippers configured to supply the stain inhibitor solution to the felt strip applicator.

When an array of drippers is used to supply the stain inhibitor solution to the felt strip applicator, it is preferable to have the flow rate from each dripper to be the same, or substantially the same.

Another way of applying the stain inhibitor solution to the felt strip applicator is to use a single dripper that traverses the length 35 of the felt strip applicator, ensuring that the stain inhibitor solution is applied at the appropriate rate.

The stain inhibitor present in the stain inhibitor solution remains on the surface of the glass after the solvent, normally water, has been removed by drying. As shown in FIG. 2, in order to assist the drying process a number of fans 49 are located downstream of the felt strip to direct air, either cold or warm, towards the upper surface of the float glass ribbon in the vicinity of zone 51. Zone 51 extends across the ribbon width. In the example shown, three fans are used. Additional fans may be provided to direct drying air perpendicular to the direction of glass travel. For a float glass ribbon moving at 300 m/hour, the film was dry within 3-4 m of the end of the felt strip. When the solution was an aqueous solution comprising adipic acid, the rapid drying resulted in very small crystals of adipic acid that covered the glass surface completely, thereby providing excellent stain resistance.

To determine the uniformity of the applied stain inhibitor to the glass surface, a 30 cm strip of the float glass ribbon was cut across the ribbon width and divided into 30 cm sections. An aqueous solution comprising adipic acid had been applied according to the method of the first aspect of the present invention to improve the stain resistance of the surface of the float glass ribbon. The amount of adipic acid on each 30 cm by 30 cm square section was measured using a titration technique. It was found that the application rate was very uniform across the ribbon, the amount of adipic acid on the surface of each square section varying by about 10%.

A float glass sheet having a major surface, wherein the major surface is covered by a uniform layer of a stain inhibitor, the stain inhibitor having been applied to the major surface by (i) applying a solution comprising the stain inhibitor to an absorbent strip; (ii) transferring solution from the wet strip to the major surface; and (iii) drying the wet major surface to leave stain inhibitor on the surface thereof, has more uniform stain resistance than a float glass sheet treated with stain inhibitor in accordance with other known methods.

FIG. 3 shows the apparatus 11 wherein the felt strip has been lifted by the linear actuator mechanism so that the felt strip is not in contact with the upper major surface of the glass ribbon. The felt strip 33 is suspended in mid air and hangs substantially vertically from metal bar 43. The felt strip is shown in a non-working configuration. The felt strip may be raised very quickly in the event of a ribbon break i.e. where the float glass ribbon has become broken, and the felt strip can be maintained in a wet or damp state very easily, thereby minimising the loss of solution with a consequence reduction in wastage. This figure shows more clearly the strip length 35 and the strip width 37. The portion 39 extends over the entire length of the strip. The portion 41 also extends over the entire length of the strip in between the two dotted lines 41a, 41b.

FIG. 4 shows a side view of the felt strip applicator 33 as shown in FIG. 2. The solution comprising the stain inhibitor is applied to the portion 41 of the felt strip in the direction of arrow 51, for example by dripping. Sufficient solution must be applied to ensure the strip is maintained in a damp or wet state. The rate of solution fed to the felt strip applicator must compensate for the rate of solution transferred to the upper major surface of the glass ribbon 21 from the portion 39. Preferably the solution is applied uniformly across the strip to ensure the strip is uniformly loaded with solution, thereby allowing a uniform transfer of solution to the upper surface of the float glass ribbon. The solution applied to the float glass ribbon 21 is shown as a film 53 on the upper surface of the flat glass ribbon 21. The film 53 covers the upper surface of the float glass ribbon because the float glass ribbon is moving in the direction of arrow 31 and the wet felt strip is in contact with the major surface of the float glass ribbon.

Solution may be directly applied to portion 39 of the felt strip.

Whilst the solution may be projected towards the felt strip, it is preferred that the solution drips under the action of gravity such that when the droplets strike the felt strip, they only have a velocity component that is perpendicular to the surface of the float glass ribbon.

In an alternative to the embodiment shown in FIG. 4, the absorbent strip, which may be a felt, may be supported by a rigid framework so that in the non-working configuration, the felt strip has substantially the same geometry as in the working configuration. The framework may be suitably arranged so that the surface of the glass article does not come into contact with the rigid framework, thereby avoiding damage to the glass surface.

FIG. 5 shows a side view of the apparatus 11 shown in FIG. 3. The felt strip 33 has been lifted to a non-working configuration by a linear actuator mechanism (that is, in the upwards direction of arrow 47). Since the felt strip 33 is flexible and is attached to the metal bar 43, the strip is able to hang freely in mid-air, being suspended above the float glass ribbon 21. The lower portion 39 of the strip is not able to contact the upper surface of the float glass ribbon 21. It may be useful to remove contact of the felt strip with the float glass ribbon in the event of the ribbon becoming broken, or if it is not desired to apply stain inhibitor to the float glass ribbon for other reasons. The float glass ribbon, which may be broken, continues to move in the direction of the arrow 31. If required, solution comprising the stain inhibitor may continue to be applied to the felt strip when the felt strip is in the non-working configuration, for example by applying solution to the felt strip in the direction of arrow 51. This figure more clearly shows the strip width 37 of the felt strip 33.

FIG. 6 shows an alternative embodiment of an apparatus according to the second aspect of the present invention for carrying out a method in accordance with the first aspect of the present invention. The applicator is a felt strip 55 that has been bent so that in cross section the applicator has a ‘U’ shape. The felt strip is therefore channel shaped. The bottom of the ‘U’ (region 77) conforms in shape to the profile of the upper surface of the float glass ribbon. Each leg of the ‘U’ may be applied with stain inhibitor, for example in the regions 57, 59. The solution may be applied in the direction of the arrows 61 and 63. Suitable means of applying the solution includes drippers. Preferably the same solution is applied to each leg, but each leg may be provided with a different solution. The application rate of solution to each leg may be different.

One of the legs is connected to a metal bar 65. The other leg is connected to another metal bar 67. Each metal bar 65, 67 extends along the strip length of the strip 55. There are linkage elements 69, 71 connected to the respective metal bar 65, 67. The linkage elements are connected to a linear actuator mechanism (not shown) to raise or lower each leg in the direction of arrows 73, 75. Preferably each leg is lifted at the same time.

By applying the solution to one or both regions 57, 59, the solution is able to permeate to the lower region 77 of the strip. As the float glass ribbon 21 moves passed the lower region 77, solution is transferred to the upper surface of the ribbon in the form of a film 53.

This configuration of felt strip applicator has the advantage that the felt strip does not have to be raised as high compared to the felt strip applicator 33 shown in FIGS. 2-5 in order that the felt strip does not contact the upper surface of the glass ribbon. In addition, it is easier to maintain this applicator in the wet state when the applicator is raised above the upper surface of the glass ribbon because in the non-working configuration the profile of the felt strip is substantially the same as the profile of the felt strip when in the working configuration.

A particularly advantageous embodiment of the present invention is shown in FIG. 7. In this example, the felt strip applicator 33 has a protective outer layer 79 of another material attached to the main body of the absorbent strip. The protective outer layer 79 is arranged to be between the upper surface of the float glass ribbon and the body of the felt strip 33 when the strip is in the working configuration. A suitable material for the protective outer layer is a fabric woven from nylon monofilament. Nylon is hardwearing and because of the continuous monofilament construction rather than the conventional twisted yarn, no filaments can be pulled loose from the protective sheet 79 as the felt strip drags across the upper surface when the float glass ribbon moves in the direction of arrow 31. Without the protective outer layer 79, filaments of the felt strip 33 may be pulled loose, thereby reducing the working life of the felt strip.

There may be other layers in between the absorbent strip and the outer layer. For example, in the embodiment shown in FIG. 7, there may be another layer sandwiched between the felt strip and the nylon sheet that assists with the spreading of the solution. The protective sheet may be absorbent.

The protective sheet must allow solution absorbed in the absorbent strip to be transferred from the body of the strip onto the surface of the glass article. The protective outer layer is more resistant to wear than the absorbent strip.

As in the embodiment shown in FIG. 4, solution may be applied directly to the portion 39 of the strip.

In an alternative embodiment, the protective outer layer may be integral to the absorbent strip. For example, the protective outer layer may be formed by treating one or both major faces of the felt strip so that one or both major faces are more hard wearing. For example, the outer surfaces may be impregnated with a suitable liquid resin that can be hardened to produce an integral protective outer layer. An outer protective layer formed in this manner must also not damage the glass surface and must allow solution to be transferred from the absorbent strip to the glass surface.

The felt strip applicator 55 shown in FIG. 6 may also be provided with a protective outer layer.

It will be readily apparent that the present invention may be practised using more than one absorbent strip. Also, when in the working configuration, the absorbent strip may have other shapes than those described herein.

It will be evident to one skilled in the art that the applicator may be used to apply other solutions to the glass surface, for example water or solutions to deposit a functional film on the surface of the glass. For example, the solution may be a sol-gel precursor. The functional films include anti-soil coatings, anti-reflection coatings, tinted coatings, hydrophobic coatings and hydrophilic coatings. The deposited film may be transparent or opaque, for example a paint.

It will further be evident that the glass sheet need not be flat, for example the glass sheet may be curved, as in the case of a sheet of bent glass for an automobile pane.

It will also be readily apparent that the applicator may be useful for applying a surface coating to other materials that are manufactured in sheet form, for example sheets of ceramic or steel.

The method according to the first aspect of the invention provides the advantage that a solution comprising a stain inhibitor may be applied uniformly to the surface of a glass article. In particular, when the glass article is a moving float glass ribbon, the method allows stain inhibitor to be applied uniformly to the ribbon across substantially the entire ribbon width for many hours, for ribbon speeds in excess of 100 m/hour.

The embodiments of the present invention shown in relation to FIGS. 2, 4, 6 and 7 may be used to uniformly deposit low amounts of stain inhibitor to the glass surface, such that acceptable stain resistance is provided to the glass surface. However it will readily be appreciated that by altering the flow rate of the solution to the absorbent strip, methods in accordance with the first aspect of the present invention may be used to deposit high amounts of stain inhibitor to the glass surface to modify the properties thereof. When the stain inhibitor is adipic acid, a low amount of stain inhibitor applied to the glass surface is in the region of 0.1 g per m², whereas a high amount of stain inhibitor applied to the glass surface is in the region of 1 g per m². Methods in accordance with the first aspect of the present invention may be used to uniformly deposit low and high levels of adipic acid to the upper surface of a float glass ribbon or sheet. There may be a coating on the upper surface of the float glass ribbon or sheet.

1-21. (canceled)

22. A method of improving the stain resistance of a surface of a glass article comprising
i) applying a solution comprising a stain inhibitor to an absorbent strip;
ii) transferring solution from the wet strip to the surface of the glass article; and
iii) drying the wet glass surface to leave stain inhibitor on the surface of the glass article.

23. The method according to claim 22, wherein a portion of the strip is covered by an outer layer and the solution is transferred to the surface of the glass article by contacting the outer layer with the glass surface.

24. The method according to claim 23, wherein the outer layer is attached to the strip.

25. The method according to claim 24, wherein the outer layer comprises a nylon.

26. The method according to claim 24, wherein the outer layer is woven from a single monofilament.

27. The method according to claim 22, wherein the strip is held in a fixed position and the glass article is moved relative to the strip so that a film of the solution is applied to the surface of the glass article.

28. The method according to claim 22, wherein the absorbent strip comprises a felt.

29. The method according to claim 22, wherein the stain inhibitor is soluble in water and is preferably chosen from the group consisting of adipic acid, zinc nitrate and boric acid.

30. The method according to claim 22, wherein the solution is transferred uniformly to the surface of the glass article, such that a uniform film of stain inhibitor solution is applied to the glass surface.

31. The method according to claim 30, wherein the variation of the weight of stain inhibitor applied to the surface of the glass article in two adjacent areas, each area having the same dimensions is less than 30%, preferably less than 20%, more preferably less than 10%.

32. The method according to claim 22, wherein the solution is applied to the absorbent strip by at least one dripper such that the solution is dripped onto the absorbent strip.

33. The method according to claim 32, wherein the flow rate of solution from each of the at least one dripper is substantially the same.

34. The method according to claim 22, wherein the amount of stain inhibitor on the glass surface is less than 2 g per m², preferably in the range 0.1 g per m² and 1 g per m².

35. The soda-lime-silica glass sheet treated with stain inhibitor according to claim 22.

36. A facility for manufacturing a glass article comprising a furnace for producing the molten glass, means for forming the molten glass into the glass article, a heating lehr for cooling the formed glass article, a conveyor mechanism for conveying the cooled formed glass article passed an apparatus arranged to apply a stain inhibitor to a surface of the glass article, the apparatus comprising an applicator being vertically disposed with respect to the conveyor mechanism, the applicator being configured to apply a solution comprising the stain inhibitor to the surface of the glass article and a feed system to apply the solution to the applicator, characterised in that the applicator is a strip of absorbent material.

37. The facility according to claim 36, wherein the absorbent strip is a felt strip.

38. The facility according to claim 36, wherein the absorbent strip comprises an outer layer configured such that the solution is applied to the surface of the glass article via the outer layer.

39. The facility according to claim 36, wherein the feed system comprises at least one dripper that is fed with the solution from a reservoir, the dripper being configured such that solution drips onto the absorbent strip.

40. The facility according to claim 39, wherein each of the at least one dripper is configured to apply solution to the absorbent strip at substantially the same flow rate.

41. The facility according to claim 36, the facility being a float line for producing float glass sheets, the article being a float glass ribbon from which the float glass sheets are cut.

42. The glass sheet having a major surface, wherein the major surface is covered by a uniform layer of a stain inhibitor, the stain inhibitor having been applied to the major surface by (i) applying a solution comprising the stain inhibitor to an absorbent strip; (ii) transferring solution from the wet strip to the major surface; and (iii) drying the wet major surface to leave stain inhibitor on the surface thereof.
